(19) United States
(12) Patent Application Publication
(10) Pub. No.: US 2012/0045731 A1
(43) Pub. Date: Feb. 23, 2012

(54) GUIDED PIN SYSTEM TREPHINE DRILL

(76) Inventor: PANKAJ PAL SINGH, Brookville, NY (US)

(21) Appl. No.: 12/860,830

(22) Filed: Aug. 20, 2010

(51) Int. Cl. A61C 3/02

(52) U.S. Cl. 433/76

(57) ABSTRACT

A guided pin system (GPS) trephine drill may be used for the placement of a dental implant while simultaneously collecting a substantial volume of autogenous bone that otherwise would have been discarded off during the current method of sequentially enlarging diameter spade drills. A method for preparing a dental implant site may include drilling the site with a pilot drill to a depth about 1 mm deeper than the intended length, in the axial direction, of the implant. The GPS trephine drill may be advanced along a straight axial path created by the pilot drill to a final depth determined by the bottoming out of a protruding pin on the trephine drill.

### BACKGROUND OF THE INVENTION

The present invention relates to apparatus and methods for placing dental implants and, more particularly, to guided pin system (GPS) trephine drills for the placement of a dental implant while simultaneously collecting a substantial volume of autogenous bone from the dental implant site.

Current tools for preparing a site for a dental implant include a plurality of spade drills. A dental surgeon may begin with a small spade drill to drill a first hole at a dental implant location. The dental surgeon may use progressively larger spade drills to achieve the desired size hole. This process results in bone shavings as the site is drilled. These bone shavings are usually discarded.

Conventional trephine drills may be used to prepare a dental implant site however, the operator must free-hand drill the bone without any guidance. This occasionally results in misdirection and over preparation of the bone.

As can be seen, there is a need for a trephine drill that may be guided into the implant site while allowing the operator to remove autogenous bone.

### SUMMARY OF THE INVENTION

In one aspect of the present invention, a trephine drill comprises a tubular body; a cutting blade at one end of the tubular body, the cutting blade adapted to cut upon rotation thereof; and a central guide pin centrally disposed within the tubular body.

In another aspect of the present invention, a dental implant preparation system comprises a pilot drill having a pilot drilling diameter, the pilot drill further having a plurality of inscribed markings along a length thereof; a trephine drill having a tubular body; a cutting blade at one end of the tubular body, the cutting blade adapted to cut upon rotation thereof; and a central guide pin centrally disposed within the tubular body, wherein the central guide pin is sized to fit into a pilot hole drilled by the pilot hole drill and guide a direction and depth of cut during use of the trephine drill.

In a further aspect of the present invention, a method for preparing a site for a dental implant comprises drilling a pilot hole, with a pilot hole drill, to a depth about 1 mm beyond a required depth for the dental implant; positioning a central guide pin of a trephine drill into the pilot hole, the trephine drill having a tubular body; a cutting blade at one end of the tubular body, the cutting blade adapted to cut upon rotation thereof; and the central guide pin being centrally disposed within the tubular body and extending about 1 mm from the cutting blade; guiding the cutting of the trephine drill by allowing the central guide pin to follow the pilot hole as the trephine drill cuts; and discontinuing cutting of the trephine drill when the central guide pin bottoms out in the pilot hole.

These and other features, aspects and advantages of the present invention will become better understood with reference to the following drawings, description and claims.

### BRIEF DESCRIPTION OF THE DRAWINGS

FIG. 1 is a perspective view of a pilot hole drill according to an embodiment of the present invention;

FIG. 2 is a perspective view of a trephine drill according to an embodiment of the present invention;

FIG. 3 is a cross-sectional view of the trephine drill of FIG. 2;

FIG. 4 is a cross-sectional view of the trephine drill of FIG. 2 in use;

FIG. 5 is a cross-sectional axial view of a boney core recovered after using the trephine drill of FIG. 2; and

FIG. 6 is a cross-sectional longitudinal view of the boney core recovered after using the trephine drill of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a guided pin system (GPS) trephine drill for preparing a dental implant site. The trephine drill may be used for the placement of a dental implant while simultaneously collecting a substantial volume of autogenous bone that otherwise would have been discarded off during the current method of sequentially enlarging diameter spade drills. A method, according to an embodiment of the present invention, for preparing a dental implant site may include drilling the site with a pilot drill to a depth about 1 mm deeper than the intended length, in the axial direction, of the implant. The GPS trephine drill may be advanced along a straight axial path created by the pilot drill to a final depth determined by the bottoming out of a protruding pin on the trephine drill.

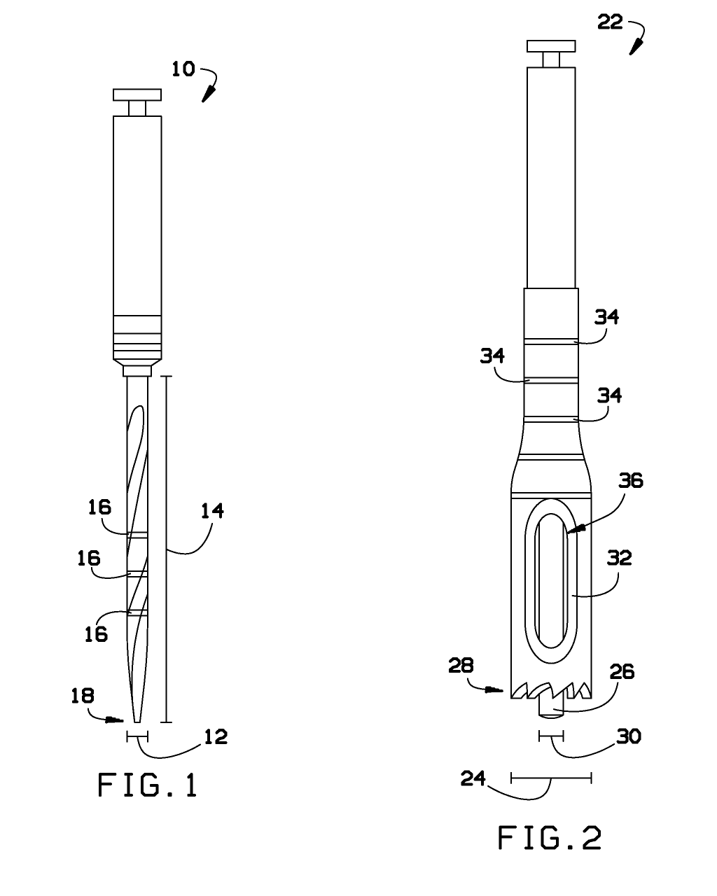

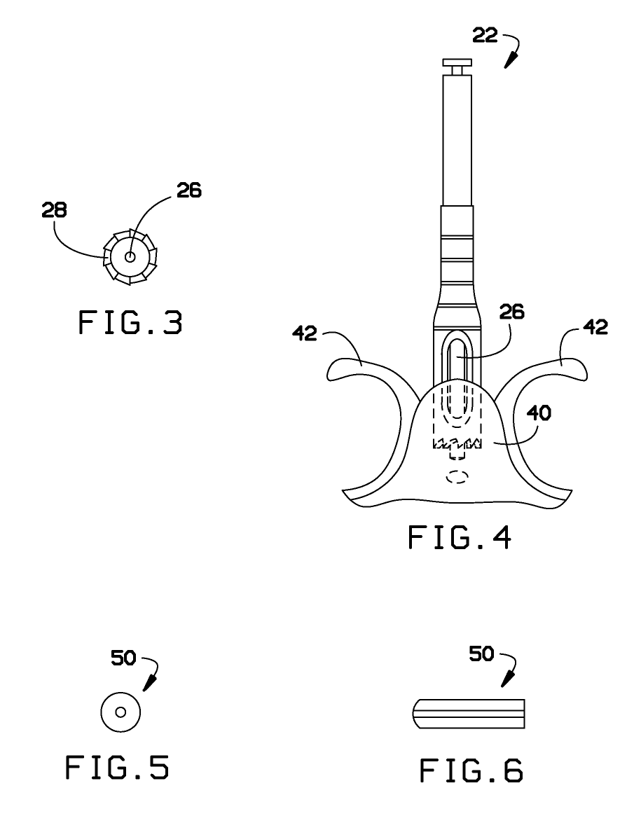

Referring to FIG. 1, a pilot drill 10 may have a diameter 12 between about 1 mm to about 2 mm. Typically, the pilot drill 10 may come in two diameters 12, either 1.3 mm or 1.8 mm. The pilot drill 10 may have a cutting length 14 from about 10 mm to about 25 mm. Typically, the pilot drill 10 may come in two cutting lengths 14, either 15 mm or 20 mm. The pilot drill 10 may include depth markings 16. The depth markings 16 may begin from about 8 mm from the pilot drill tip 18 and may include markings 16 spaced apart by 2 mm. The pilot drill 10 may be adapted to fit into standard latch type dental handpieces (not shown). The pilot drill 10 may include color markings 20 to indicate the diameter 12 and length 14 of the pilot drill 10. For example, blue and green may be used to indicate 1.3 mm and 1.8 mm diameters, respectively. The pilot drill 10 may be autoclavable and reusable.

Referring to FIG. 2, a trephine drill 22 may have a cutting diameter 24 between about 4 mm to about 8 mm. Typically the trephine drill 22 may have cutting diameters 24 of 4 mm, 4.5 mm, 5 mm, 5.5 mm, 6 mm, 6.5 mm, 7 mm, 7.5 mm and 8 mm. The trephine drill 22 may include a built-in central guide pin 26 that may extend about 1 mm past cutting edges 28 of the trephine drill 22. The central guide pin 26 may have a diameter 30 that may match the diameter 12 of the pilot drill 10. For example, the central guide pin 26 may have a diameter of either 1.3 mm or 1.8 mm. Walls 32 of the trephine drill 22 may be no greater than about 1 mm thick. The trephine drill 22 may have lengths that match the length 14 of the pilot drill 10. For example, if the pilot drill 10 is available in two lengths, 15 mm and 20 mm, the trephine drill 22 may be available in two lengths, 15 mm and 20 mm. The trephine drill 22 may have markings 34 on an outer edge thereof. The markings 34 may be laser inscribed markings that may begin from about 8 mm from the cutting edges 28 of the trephine drill 22 and may include markings 34 spaced apart by 2 mm. The trephine drill 22 may have window cut outs 36 to allow for venting of bodily fluids and for easy removal of the extracted core (not shown) from inside the trephine drill 22. The trephine drill 22 may be autoclavable and reusable.

Referring to FIG. 4, the trephine drill 22 may be used to prepare a site for a dental implant (not shown). The pilot drill 10 may first drill a pilot hole in the bone 40 between the soft tissue of the gums 42. The pilot hole may be drilled about 1 mm longer than the indented length, in the axial direction, of the implant. This additional 1 mm may allow the central guide pin 26 to bottom out with the cutting edges 28 cutting a hole 1 mm above this bottom out position, as shown in FIG. 4. Typically, the cutting diameter 24 of the trephine drill 22 is greater than the size of the implant but no greater than about 0.5 mm larger than the outer diameter at the neck of the implant. The pilot hole may permit the trephine drill 22 to be advanced along a straight axial path.

Referring to FIGS. 5 and 6, a core of bone 50 may be removed by the trephine drill 22. The bone 50 may be saved for grafting, leaving behind an osteotomy ready for implant placement in softer bone, bypassing the need for use of final shaping drills used for dense bone. The extracted bone 50 may be used to augment any hard tissue defects that need to be corrected either at or near the implant or in another part of the jaw (i.e., subantrum for a sinus lift or extraction site for socket preservation) for future implant placement.

The pilot drill 10 and the trephine drill 22 may be manufactured with hardened surgical stainless steel using standard drill making protocol. In one embodiment, computer aided design (CAD) drawings may be transferred to a CAM unit to mill out the instruments.

The apparatus and methods of the present invention, using a GPS trephine drill, as compared to traditional spade drills, may enable the implant surgeon the ability to not only simplify and streamline the surgical placement of implants and minimize trauma to the area by using fewer instruments, but also allows the implant surgeon to collect vital autogenous bone in a larger volume as compared to conventional methods. The ability to collect autogenous bone may eliminate or decrease the need for a secondary donor site or for the use of alternative non-autogenous sources. The autogenous bone, considered the gold standard in bone grafting, is invaluable in simultaneous augmentation procedures, further decreasing the cost of performing the implant procedure.

It should be understood, of course, that the foregoing relates to exemplary embodiments of the invention and that modifications may be made without departing from the spirit and scope of the invention as set forth in the following claims.

What is claimed is:

1. A trephine drill comprising:
a tubular body;
a cutting blade at one end of the tubular body, the cutting blade adapted to cut upon rotation thereof; and
a central guide pin centrally disposed within the tubular body.

2. The trephine drill of claim 1, wherein the central guide pin extends about 1 mm beyond the cutting blade.

3. The trephine drill of claim 1, further comprising at least one window cut into the tubular body.

4. The trephine drill of claim 1, wherein walls of the tubular body are no more than about 1 mm thick.

5. The trephine drill of claim 1, wherein:
a diameter of the central guide pin is from about 1 mm to about 2 mm; and
a diameter of the tubular body is from about 4 mm to about 8 mm.

6. The trephine drill of claim 1, further comprising inscribed markings along the length of the tubular body.

7. A dental implant preparation system comprising:
a pilot drill having a pilot drilling diameter, the pilot drill further having a plurality of inscribed markings along a length thereof;
a trephine drill having a tubular body; a cutting blade at one end of the tubular body, the cutting blade adapted to cut upon rotation thereof; and a central guide pin centrally disposed within the tubular body, wherein
the central guide pin is sized to fit into a pilot hole drilled by the pilot hole drill and guide a direction and depth of cut during use of the trephine drill.

8. The dental implant preparation system of claim 7, further comprising at least one window formed into the tubular body, wherein
the central guide pin extends about 1 mm beyond the cutting blade; and
walls of the tubular body are no more than about 1 mm thick.

9. A method for preparing a site for a dental implant, the method comprising:
drilling a pilot hole, with a pilot hole drill, to a depth about 1 mm beyond a required depth for the dental implant;
positioning a central guide pin of a trephine drill into the pilot hole, the trephine drill having a tubular body; a cutting blade at one end of the tubular body, the cutting blade adapted to cut upon rotation thereof; and the central guide pin being centrally disposed within the tubular body and extending about 1 mm from the cutting blade;
guiding the cutting of the trephine drill by allowing the central guide pin to follow the pilot hole as the trephine drill cuts; and
discontinuing cutting of the trephine drill when the central guide pin bottoms out in the pilot hole.

10. The method of claim 9, further comprising removing and saving cut bone from the trephine drill for future use in the dental implant.
